(19) United States
(12) Patent Application Publication
(10) Pub. No.: US 2004/0054832 A1
(43) Pub. Date: Mar. 18, 2004

(54) Interrupt-controller with prioity specification

(76) Inventors: Joerg Franke, Freiburg (DE); Joachim Ritter, Loerrach (DE)

Correspondence Address: Patrick J O'Shea, Samuels Gauthier & Stevens, Suite3300, 225 Franklin Street, Boston, MA, 02110, US

(21) Appl. No.: 10/450,799

(22) PCT Filed: Dec. 14, 2001
(86) PCT No.: PCT/EP01/14794

(30) Foreign Application Priority Data
Dec. 16, 2000 (DE) 100 62 996.2

(51) Int. Cl. G06F 13/24

(52) U.S. Cl. 710/260

(57) ABSTRACT

The invention relates to an interrupt controller (1) for controlling the access of interrupt sources (11, 12, 13, 14) to a processor (100) and for controlling the associated program branching of the signal processing being currently executed with a current priority (Px) in the processor. The input side of the interrupt controller (1) contains a specified number of interrupt interfaces (21, 22, 23, 24) for connecting the interrupt sources, a priority value (Pi) and an address (Adi) being allocated to each interrupt interface (21, 22, 23, 24). A selection device (30) determines which among the activated interrupt interfaces has the highest priority value (Pmax). The interconnection of the individual interrupt interfaces (21, 22, 23, 24) to the processor (100) as an interrupt request (IR) is dependent on a priority comparator (40) and a branching logic (60) which control the triggering of a context backup in the processor (100) as a function of the determined priority value (Pmax) and the current priority value (Px), or a pseudo-priority value (Pp) which is contained in a register (45).

The invention relates to an interrupt controller which controls the access of a plurality of interrupt sources to a processor which is designed to switch the current program in accordance with the particular active interrupt source. An example here would be a processor in a motor vehicle which is currently operating a noncritical program such as one regulating the heating or ventilation. If during this time a temperature sensor in the engine reports overheating, the processor must be switched to an engine control program to prevent any damage from occurring in the engine. The resulting conflict in which two or more interrupt sources simultaneously send signals to switch programs is then resolved by having the interrupt controller switch through the individual interrupt sources successively to the interrupt input of the processor only according to specified priorities. To achieve this, each interrupt source is connected to its own interrupt interface which is individualized by an address and a specified, in particular, programmable, priority value. In addition, at least two settable status registers (=flags) are generally allocated to each interrupt interface from which the interrupt controller detects an interrupt request triggered by the interrupt source, while also indicating to the interrupt source the enabling or disabling of the particular interrupt interface.

All the interrupt interfaces are coupled to a selection device which searches through the incoming interrupt requests for the one with the highest priority. A priority comparator then compares the highest priority as determined by the selection device with the priority of the currently running program and sends an interrupt request to the interrupt input of the processor if the requested priority is higher than the priority of the current program. If the priority is lower, the current program continues uninterrupted. Since the processor is generally not able to switch to the higher-priority program immediately even when given a high priority from the interrupt request, an exchange of request and enabling signals takes place between the processor and the interrupt controller, the process customarily being designated as a handshake procedure. A branching logic in the interrupt controller is supplied with the priority of address of the highest-priority interrupt interface for which the program branching is queried by the processor. The branching logic generally also controls the handshake procedure and provides the associated signals.

The branching commands given by the branching logic trigger different interrupt routines in the processor which are allocated to the particular priority of the interrupt interface to be switched through, but which also always contain a context backup routine. In the context backup routine, the following operations are generally performed: the program currently running in the processor is halted, the information of the registers present in the processor core is loaded into separate memory regions, the return address to the interrupted program is determined and saved, and certain flags are set or deleted. For example, within the individual section of the particular interrupt routines, new information is read into certain registers of the processor core, such as fixed coefficients. The already mentioned exchange of request, standby, and disabling signals between the interrupt controller and the processor ensures that the currently running program can be interrupted only at the specifically allowable locations.

The time period for data backup in the processor here is not negligible but requires, depending on the interrupt routine, between 10 and 30 clock pulses, for example. While the individual interrupt routines are executing, new interrupt requests may be detected only by setting the corresponding flags in the associated interrupt interface. Evaluation of these set flags may only take place if the interrupt routine has been executed in the processor, and this has been indicated by corresponding signals to the branching logic. The idle period for new interrupt requests during context backup constitutes a significant fraction of the total idle period, and is also termed the latency period.

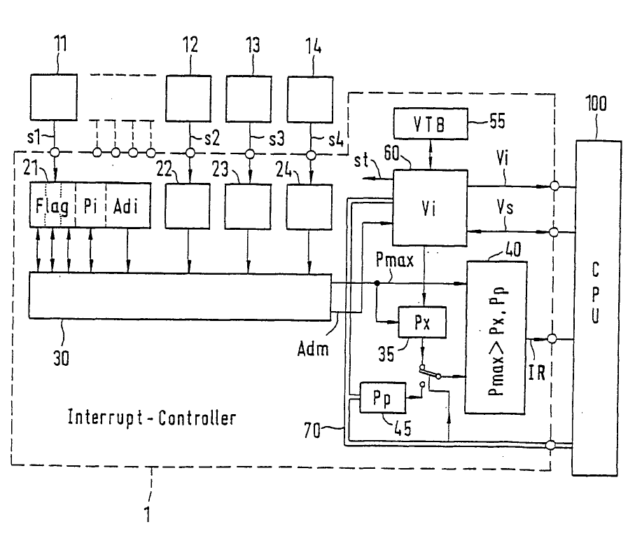

An interrupt controller containing these functional units is described, for example, in the data sheet from the company Micronas Intermetall, dated Sep. 29, 1999 under the title “CEVF-3 V3.2 Dashboard Controller Emulator,” order number 6251-479-3PD, Part 9: “Interrupt Controller (IR) V1.5” on pages 71 through 79; see, for example, the block diagram in FIGS. 9-1 on page 72.

In a concurrent patent application, a modification of the interrupt controller has received patent protection, the controller, in connection with conventional processors, having a smaller latency period. Occasionally, however, the opposite problem occurs in which the goal is not to interrupt a currently running program, or at most to allow only certain interruptions. Areas of application here can be found, for example, on a test stand when the requirement is to test out an operational process extending into regions which are actually prohibited. No test is possible if a separate emergency program has been provided for this over-range, however. For this reason, total disabling of all program branches is generally possible in conventional processors through a separate control input; however, partial disabling, in which the requirement is to allow some program branches and not others, is not possible. Since the setting of interrupt sources to be disabled should be modifiable on a case-by-case basis, a flexible control is desirable.

The goal of the invention is therefore to modify an interrupt controller such that it has greater flexibility, in terms of the program branches to be disabled, than the total disabling of all program branches by one or more control commands.

The goal is achieved according to the invention by an interrupt controller according to the preamble of claim 1 wherein the current priority value is replaced in a priority comparator during execution of the current program by a higher priority value, a pseudo-priority. This has the advantage over a conceivable control using additional control signals that it is extremely effective despite its simplicity. For example, it is not necessary to disable certain, namely addressable, interrupt interfaces by setting a special flag, or conversely, setting an enable flag for allowable interrupt interfaces. The priority comparator is allowed to perform the desired flexible control simply by specifying a freely selectable pseudo-priority value instead of the current priority value. As a result, program branching specified by the original priority ranking may be temporarily suspended in the simplest possible manner.

The invention and advantageous embodiments are explained in more detail based on the drawing. The single figure is a block diagram of an interrupt controller having a device for priority specification according to the invention.

The block diagram according to the figure shows the functional units of an interrupt controller 1 which is generally in the form of a monolithic integrated circuit. The figure additionally shows four external interrupt sources 11, 12, 13, 14, and an external processor 100 (=CPU). The interrupt sources here may be processors, detectors or sensors which generate data or analog signals s1, s2, s3, s4 which function as switching signals for processor 100. While the figure shows only four interrupt sources, as a rule 16 or more such interrupt sources may be connected to one interrupt controller.

An interrupt interface 21, 22, 23, 24 is allocated to each interrupt source 11, 12, 13, 14, each interrupt interface representing the particular input circuit of the interrupt controller. The interrupt interfaces here may be of the same design or of different designs, depending on the type of connectable interrupt sources. As identification, each interrupt interface has its own address Adi and an associated priority value Pi which is advantageously programmable through a bus line, not shown. In addition, a status register area (=flag area) is allocated to each interrupt interface to indicate, by corresponding status signals (=flag), an external interrupt request, the standby acceptance status to receive signals sent by the interrupt source, or other states.

A selection device 30 determines from among current interrupt requests which has the highest priority Pmax together with the associated address Adm. A priority comparator 40 compares this priority value Pmax with a currently valid priority value Px, then generates an interrupt request IR if the priority value is higher than the current priority value Px. The new priority value Pmax is then saved as the new current priority value Px, for example, in a register 35, so as to be available again for the current priority comparison in response to the next interrupt request. If the priority value Pmax is smaller than the current priority value Px, this value does not need to be saved.

If the priority comparator 40 recognizes that the supplied priority value Pmax is higher than the current priority value Px, it then uses an interrupt request signal to report an interrupt request IR to processor 100 which is processed there as an interrupt routine as soon as the currently running program allows. A context backup of the current program takes place in each interrupt routine, during which both the data linked with the processor core and the return address to the interrupted program are saved. Either during or after context backup, the processor core may be initialized for the new program to be processed. Processor 100 receives the information Vi on the new program to be processed from a branching logic 60 which exchanges the appropriate information with the processor via control signals Vs, and possibly via a handshake procedure, the information being located, for example, in register 55, which was loaded by the branching logic previously. With this information Vi, the program pointer of the processor receives, either directly or indirectly, information on the internal start address of the new program or on the associated interrupt routine. Switching of the various status signals corresponding to the particular operating status of interrupt controller 1 is essentially also controlled by branching logic 60 via the internal control signals st indicated in the circuit.

This program sequence controlled by the priorities is now employed, as indicated above, to achieve the proposed goal in an extremely simple manner whereby in the priority comparator the priority comparison is not made with the current priority value Px but with a pseudo-priority value Pp. To this end, the pseudo-priority value is advantageously extracted from register 45 which is coupled to priority comparator 40, and which may be loaded through a usually present read/write bus. Register 45 may also contain memory regions for status signals, and an address. Connection to and disconnection from priority comparator 40 is effected by appropriate control signals or when the saved address matches a certain interface address Adi. Specification of the pseudo-priority ensures that the current program may only be interrupted by higher priorities. If the intention is that it not be interrupted at all, then the highest possible priority level is used as the pseudo-priority. The control signal for complete disabling of branching, and possibly the circuit connection required for it, are therefore not even required.

1. Interrupt controller (1) for controlling access by interrupt sources (11, 12, 13, 14) to a signal input of a processor (100) and for branching a program currently being executed in the processor, wherein
the input side of the interrupt controller (1) contains a specified number of interrupt interfaces (21, 22, 23, 24) to connect the interrupt sources,
a priority value (Pi), in particular, a programmable priority value, and an address (Adi) are allocated to each interrupt interface (21, 22, 23, 24)
a selection device (30) searches out, from the interrupt interfaces activated by the interrupt sources, the interrupt interface with the highest priority value (Pmax) and its associated address (Adm),
a priority comparator (40) generates an interrupt request (IR) as a function of the highest priority value (Pmax) determined by the selection device, and as a function of the current priority value (Px) which triggers a context backup in the process, and
a branching logic (60) generates a branching address (Vi) in response to the highest priority value (Pmax) determined by the selection device (30),
characterized in that
the current priority value (Px) is replaced in the priority comparator (40) during execution of the current program by a higher priority value, a pseudo-priority value (Pp), which, in particular, is contained in a register (45).

2. Interrupt controller (1) according to claim 1, characterized in that the register (45) is programmable.

3. Interrupt controller (1) according to claims 1 or 2, characterized in that the pseudo-priority value (Pp) saved in the register (45) is coupled to an address simultaneously saved in the register (45), which address is allocatable to an interface address (Adi).

4. Interrupt controller (1) according to one of claims 1 through 3, characterized in that the register (45) is activated or disabled through control signals, in particular, the setting of flags.
